(19) United States
(12) Patent Application Publication
(10) Pub. No.: US 2025/0135729 A1
(43) Pub. Date: May 1, 2025

(54) Method and Apparatus for Connecting and Reinforcing Pre-Manufactured Parts

(71) Applicant: Adelie Blue Technologies, LLC, Spanish Fort, AL (US)

(72) Inventors: Kuang-Ting Hsiao, Spanish Fort, AL (US); Emma A. Hsiao, Spanish Fort, AL (US); Michael A. Hsiao, Spanish Fort, AL (US); Juowen R. Mao, Spanish Fort, AL (US)

(73) Assignee: Adelie Blue Technologies, LLC, Spanish Fort, AL (US)

(21) Appl. No.: 18/796,526

(22) Filed: Aug. 7, 2024

Related U.S. Application Data
(60) Provisional application No. 63/545,578, filed on Oct. 25, 2023.

(51) Int. Cl. B29C 65/48; B29C 65/00; B33Y 40/20

(52) U.S. Cl. CPC B29C 65/48; B29C 66/7212; B33Y 40/20

(57) ABSTRACT

The present invention provides a novel and effective solution for connecting, reinforcing, sensing, and/or actuating pre-manufactured parts (such as 3D-printed parts), and also, optionally add multi-functionalities to the system; the multi-functionalities include but are not limited to fluid transportation, mass transfer, heat transfer, energy harvest from and energy emission to the surrounding environment; signal communication and energy transportation.

### CROSS REFERENCE TO RELATED APPLICATIONS

This application claims priority to, and the benefit of, pending U.S. Provisional Patent Application No. 63/545,578 filed Oct. 25, 2023.

### FIELD OF THE DISCLOSURE

The present disclosure relates generally to an apparatus and method of connecting and strengthening manufactured articles.

### BACKGROUND

Additive manufacturing, or “AM” (i.e., 3D-printing) is the process of creating an object by building it layer by layer. In contrast to AM, traditional forms of manufacturing such as subtractive manufacturing create an object by cutting away material from a mass until the desired geometry is achieved. Although AM processes are still developing, they already offer numerous benefits. One of the most influential advantages of AM is the high degree of customization and flexibility offered through the digital design and manufacturing.

There are a few concerns common to AM. One of the most common limitations lies in the slow speed in producing parts. Although AM can be effective at producing unique and individual designs quickly, it can take hours and sometimes days to print one object, making it less productive compared with traditional mass manufacturing methods. Another common concern surrounds the quality of the prints and preventing delamination of the layers. Lamination quality also needs to be monitored and improved, especially as issues from quality/delamination combined with slow printing speed and individual filament's characteristics (i.e., shrinking, and low elastic modulus from elastomers such as rubber or silicone) can lead to a significantly higher chance of filament deposition failure in printing large parts and make printing large parts extremely difficult, costly, or impractical. Although all of these limitations pose challenges, one of the most prominent drawbacks to AM is the size limit. Since AM printers are only able to print objects smaller than the printer casing, one product often needs to be manufactured in segments to later be assembled (as described in U.S. Pat. No. 9,873,229B2), much like some traditional assembly approaches of parts manufactured through subtractive manufacturing. However, size limitations create major obstacles, in both additive and subtractive manufacturing, in joining the sections strongly and effectively. There are many different traditional joining methods (for example, grooves, hinges, screws, 3D fitting plugs, magnets, crossbars, dents, and wedges were mentioned in U.S. Pat. No. 9,873,229B2 to connect multiple computer-designed AM produced parts into a big three-dimensional object), and all the existing and popular methods can be approximately categorized into four distinct classes below.

One of the most popular and prominent methods to join AM produced parts is through the use of adhesives such as super glue, epoxy resin, urethane glue, and other alternatives. Working by creating a bond between the surfaces of the parts and the adhesive, this option provides relatively strong and permanent attachments, which can be further enhanced through the sanding and polishing of the surfaces in the bonding area. However, adhesive bonding may not work well for incompatible materials.

Another common method to join AM produced parts is through physical connecting and locking mechanisms, included in the part during model design. These typically can include printed snap-fit joints between two parts (e.g., click-on joints between two printed parts), printed threads, and hinges, like the traditional assembly methods used for parts manufactured through subtractive manufacturing. However, the mechanical joints tend to be the weakest portion of the assembly.

Another popular method to join AM produced parts is through melting and/or welding. Melting and welding provides a major advantage compared to other techniques, as it is able to be smoothed and shaped through sanding. However, this may be a more challenging option as it can be difficult and messy to operate. Sometimes, it could also be difficult to find sufficient accessible surface for achieving satisfactory welding results. The prior art teaches that in addition to the traditional welding process which required completely melting the materials at the joregion andface, a solid-state process was used to join dissimilar materials; the process (US 2021/0197457 A1) “include feeding a first material through a hollow tool of a solid-state additive manufacturing machine to contact a second material, generating deformation of the materials by applying normal, shear and/or frictional forces using a rotating shoulder of the tool such that the materials are in a malleable and/or visco-elastic state in an interface region and mixing and joining the materials in that region.” Such solid-state joining method utilized the physics of the commonly known “friction stir welding” process that is slightly different from traditional welding processes (which required melting the materials to liquid-state) but still joins/mixes the materials at the interface of two parts to be welded. Therefore, this type of solid-state joining method such as the “friction stir welding” can still be approximately categorized as this class.

The last method commonly used to connect AM produced parts is through the use of fasteners such as screws and nuts/bolts, like the approaches to join parts produced by traditional subtractive manufacturing with screws, and nuts/bolts. The common weak points could be the portion accommodating the fasteners; therefore, significantly increased wall thickness usually would be required near the fastener accommodating portion.

Although each existing class of these joining methods has their strengths and weaknesses, most of them still suffer the low mechanical strengths inherited from the parts. One method to increase the strength of the AM produced object is by adding reinforcing cores, structures, and better materials. The materials for reinforcement can vary depending on the needs.

Carbon fiber is a strong, lightweight material with numerous advantages including high tensile strength, high chemical resistance, and high temperature tolerance. One of the more common, earlier methods of incorporating carbon fiber into printed materials was to cut the fiber into short strands (about or less than 1 mm to avoid printer's nozzle clogging) and combine it with the thermoplastic to then extrude during printing. However, in order to accommodate these changes, a significantly more complex model needs to be designed. Furthermore, in the design, orientation and quality of the fiber needs to be considered. It is known in the prior art that continuous carbon fiber, which is stronger than short carbon fiber, can also be used for 3D printing to achieve stronger 3D printed parts.

Using carbon nanofibers to z-directionally thread among continuous carbon fibers/polymer filament (manufacturing process patented, U.S. Pat. No. 10,556,390B2, by Hsiao) and using the filament for 3D-printed composite parts successfully achieved about an 11 percent increase in the inter-laminar shear strength compared to continuous carbon fiber reinforced polymer composite parts manufactured by a traditional molding method (Islam et. al., 2023) [please add the new reference to support the 11 percent improvement: Islam, Mohammad Rakibul, Wyatt Taylor, Ryan Warren, and Kuang-Ting Hsiao. 2023. “Enhancing the Interlaminar Shear Strength and Void Control of 3D-Printed Continuous Carbon-Fiber-Reinforced Polymer Composites Using a Robotic Magnetic Compaction Force-Assisted Additive Manufacturing (MCFA-AM) Process and Carbon-Nanofiber Z-Threads” Applied Sciences 13, no. 10 5914. https://doi.org/10.3390/a U.S. Plant Pat. No. 13,105,914]. In addition, they also utilized a patented 3D printing method (U.S. Pat. No. 11,426,935B2, by Hsiao) that emitted a magnetic field to apply compaction pressure during the 3D-printing process to remove voids and defects during the filament deposition process.

The carbon fiber in the filament can also serve as sensors as taught by U.S. Pat. No. 8,451,013B1 by Hsiao. Although there are strain gauges, optic sensors, and other monitoring devices, these can increase the weight of the structure and potentially weaken it with the embedding of the sensors. According to U.S. Patent No. 8,451,013B1 by Hsiao, single or multiple insulated carbon fibers (i.e., one or more multiple carbon fibers insulated with very thin polymer coating) can be used as embedded sensor(s) inside a carbon fiber composite part. The insulated carbon fiber sensor can be used to measure stress, temperature, and monitor the damage of composite parts. Therefore, utilizing the carbon fiber that is already acting as a reinforcement to serve as a sensor can greatly improve the performance of structures. A modified technique (GB 2,531,522 A) of using carbon fiber as strain sensor(s) in composite materials has been disclosed by coating particular types of electrically conductive materials to reduce the measurement errors caused by temperature change. Due to the high electrical conductivity, piezo-resistance properties, and low density, carbon fiber has many properties to help monitor the integrity of the printed part as well as to reinforce it. In addition to the carbon fiber in the filament, smart materials such as shape memory polymers and liquid crystal elastomer (which could be excited by heat or light to achieve large deformation) can also be incorporated to bring more functions and utilities in AM.

As addressed above, there are several limitations to AM (or 3D-printing) known in the art. The purpose of this invention is to provide a novel and effective solution for connecting, reinforcing, sensing, and/or actuating pre-manufactured parts (such as 3D-printed parts), and also, optionally add multi-functionalities to the system; the multi-functionalities include but are not limited to fluid transportation, mass transfer, heat transfer, energy harvest from and energy emission to the surrounding environment; signal communication and energy transportation.

In addition to the afore-mentioned basic features and multi-functionality features, this invention also focuses on enabling great re-usability of almost all of the components in the assembly and thus, provides the advantages of making it easy to assemble and disassemble, easy to repair, and easy to modify the assembly. Therefore, the invention is also a novel green technology to enhance sustainability through manufacturing innovation and reusable modularized assembly design.

### BRIEF DESCRIPTION OF THE DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows one embodiment of the present invention being used to connect two or more pre-manufactured parts.

FIG. 2 shows one embodiment of using a deformation control device in connection with the present invention.

FIG. 3 shows one embodiment of using a buffer layer in connection with the present invention.

FIG. 4 shows one embodiment of an installation and/or assembly method of the present invention.

FIG. 5 shows the addition of certain sensors, ducts, actuators, and remote signal communication devices being used in connection with the present invention.

FIG. 6 shows connecting two of more slender pieces.

An Appendix is included herewith that illustrates several prototypes of the present invention.

### DETAILED DESCRIPTION

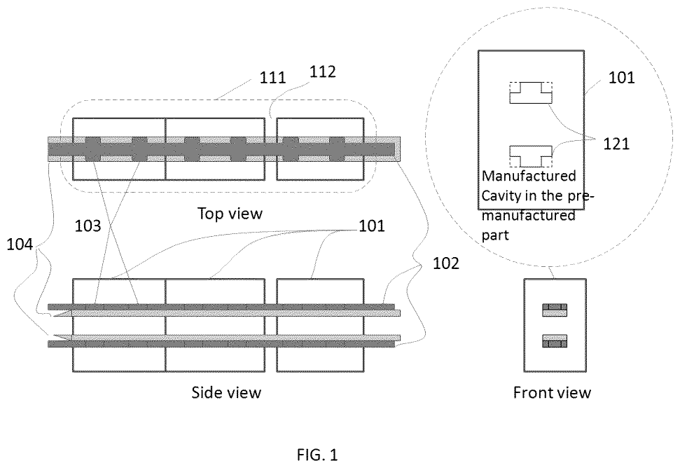

Now referring to FIGS. 1-6, the apparatus and method of the present invention will be described. FIG. 1 shows how the present invention connects two or more pre-manufactured parts. It also shows how to reinforce the pre-manufactured parts and assembly.

Pre-manufactured part 101, or item, as provided in FIG. 1 can be, but is not limited to 3D-printed parts, additively manufactured parts, molded parts or subtractively manufactured parts. Generally, it is desirous to join/connect these pre-manufactured parts 101 for some purpose. Slender piece 102 has very high mechanical tensile strength and tensile modulus along the longitudinal direction. Optionally, slender piece 102 may contain further reinforcement such as carbon fiber, Kevlar® fiber, ceramic fiber, glass fiber, polymer fiber, natural fiber, and fiber or wire made of shape-memory material.

The slender piece 102 has a slenderness ratio defined as the ratio of the length to the thickness (or diameter if circular cross-section is adapted for the slender piece). Said slenderness ratio is larger than a number from the following options about 5, 10, 20, 30, 50, 100, 1000, 5000, 10000, or higher. The slender piece 102 can be manufactured via continuous manufacturing processes such as but not limited to extrusion or pultrusion processes, so it could be produced with the “product length” as about 5, 10, 25, 50, 100, 1000 meters or longer (for example for space/orbital applications, under sea applications, and infrastructural applications, long continuous slender piece more than several kilometers (e.g., 10 km) long could be useful, when considering its other multi-functions, reinforcing effect, and connecting ability), and collected as a roll for easy storage, transportation, distribution, and sale. For another example, a thicker, slender piece 102 designed for construction industry market (such as for bridge decks quick connection and reinforcement) could have thickness of 6 inches and length of 5280 feet (i.e., 1 mile=5280 feet), which would yield a slenderness ratio of 10,560. For the same 6-inch thickness, slender piece 102 having a length of 50 feet, would have a slenderness ratio of 100.

As each market segment such as aerospace, automotive, construction, marine, etc., would have different preferred reinforcement and connection needs along with their typical structure length ranges, suitable thickness and length of the slender piece will be optimized for individual customer segments' needs.

Another essential characteristic of the slender piece 102 is that it has good bending flexibility and twisting flexibility (its smallest bending curvature radius can be as small as 1-10 times of the thickness of the slender piece, depending on the detailed geometry design, construction and the materials used to manufacture the slender piece, and the bending is highly (about fully) reversible and recoverable; it can be twisted 360 degrees with a length as short as 1-50 times of its thickness, and twisting is highly (about fully) reversible and recoverable), so it can be inserted/fed through curved cavity (i.e., curved channel) inside a pre-manufactured part 101; therefore, the highly flexible slender piece can provide reinforcement along the curved path in addition to straight path. Note this scenario can occur if the part geometry is complex or the curved cavity is desired to achieve certain local path dependent physical characteristics (e.g., directionally reinforcing a part or providing desired multi-functionalities (such as heat transfer) along a certain curved path rather than a straight path) inside the pre-manufactured part.

The slender piece 102 is embedded inside the pre-manufactured part 101. In an embodiment, a pre-manufactured part 101 is fully penetrated by a slender piece 102. In another embodiment, a certain percentage of the length of pre-manufactured part 101 is penetrated by a slender piece 102, where said certain percentage is no less than 10%, 20%, 30%, 40%, 50%, 60%, 70%, 80% or 90%. In other words, in one embodiment, the slender piece 102 is only partially inserted. In one embodiment, the slender piece 102 surface is flush with the surface of the pre-manufactured part. In another embodiment, the slender piece is embedded inside the pre-manufactured part with a depth under the part surface, where said depth is no less than the thinnest wall thickness of the method used to make the cavity (i.e., channel) inside the pre-manufactured part. In another embodiment, said depth is no less than 1 mm. In one embodiment, a long slender piece 102 can be cut or trimmed into a shorter length; for example, a slender piece 102 can be provided as a roll (like a roll of cable) and the user can cut any desired length of slender piece 102 from the roll for the needs of applications. In another embodiment, multiple slender pieces 102 can be extended or retracted and then fixed with fixtures/pins (e.g., the slender pieces can be hollow with multiple layers of slender pieces to slide against each other for desired extension or retraction); this retractable design of the slender pieces 102 can also be effectively stored through retractable functions. For example, but not limited to, a set of multiple slender pieces 102 that can have a hollow interior that holds multiple layers of slender pieces to extend or retract, and the length of the retractable slender pieces set can be adjusted and then fixed with fixtures such as pins or screws. In another embodiment, two or more slender pieces 102 can be connected together to extend the overall length or make a complex network. Cavity 121 is inside the pre-manufactured part 101 and can accommodate the slender piece 102 and securing element 103. When it is desired, said cavity 121 can also accommodate the optional jamming means 104 (all of which are discussed below).

Still referring to FIG. 1, securing element(s) 103 secures the slender piece 102 with a pre-manufactured part 101 and effectively transfers the mechanical load between the slender piece 102 and the pre-manufactured parts 101. The securing element(s) 103 effectively connects, fastens, or secures a slender piece 102 and a pre-manufactured part 101 in a manner that the slender piece 102 provides strength along the slender piece's 102 path/direction. In an embodiment, “strength” refers to a selection from tensile strength, compressive strength, or combination of both. In another embodiment, said “strength” is shear strength that shears across the slender piece's 102 path/direction. In one embodiment, the slender piece 102 and securing elements 103 make the connection between the pre-manufactured parts 101 significantly stronger than one or all of the following joining methods that directly applied on the connected surfaces between the pre-manufactured parts such as adhesives, printed physical connecting/locking mechanisms, melting/welding, and fasteners by many times (e.g., 1.5, 2, 5, 10, 20, 50, 100, 500 times, or higher). For example, a carbon fiber has tensile strength of 7000 MPa (T1100S carbon fiber by Toray®) which is much higher than the reported single lap shear bonding strength at around 0.76 MPa of epoxy bonded acrylonitrile styrene acrylate (ASA) 3D-printed parts (Yap et al. 2020); therefore, one can confidently expect one or more slender piece(s) 102 consisting of carbon fibers along with properly engineered/calculated/designed securing elements 103 can deliver superior connection strength compared with the adhesive/bonding joint for two 3D-printed ASA parts.

Still regarding the reinforcement results, in one embodiment, when a slender piece 102 is properly installed and working with the pre-manufactured part(s) 101 or the assembly 111 with the help of the securing element(s) 103, said slender piece 102 significantly reinforces the overall tensile strength and compressive strength of the pre-manufactured part(s) 101 or the assembly 111 in the slender piece's path direction; in addition, the overall tensile stiffness and compressive stiffness of the pre-manufactured part(s) 101 or the assembly 111 can also be reinforced significantly. In another embodiment, when a slender piece 102 is properly installed and working with the pre-manufactured part(s) 101 or the assembly 111 with the help of the securing element(s) 103, said slender piece 102 significantly reinforces the overall shear strength of the pre-manufactured part(s) 101 or the assembly 111 along the direction perpendicular to the slender piece's path direction. In another embodiment, when multiple slender pieces 102 are properly installed and working with the pre-manufactured part(s) 101 or the assembly 111 with the help of the securing elements 103, said multiple slender pieces 102 (or a long slender piece 102 bent to create a mechanical structure similar to that created by said multiple slender pieces 102 (e.g., looped configurations of one long slender piece 102)) significantly reinforce the overall bending strength and bending stiffness of the pre-manufactured part(s) 101 or the assembly 111. In a further embodiment, when multiple slender pieces 102 are properly installed and working with the pre-manufactured part(s) 101 or the assembly 111 with the help of the securing elements 103, said multiple slender pieces 102 (or a long slender piece 102 bent to create a mechanical structure similar to that created by said multiple slender pieces 102 (e.g., looped configurations of one long slender piece 102)) significantly reinforce the overall torsional strength and torsional stiffness of the pre-manufactured part(s) 101 or the assembly 111. Furthermore, since the slender piece 102 is flexible and highly (about fully) reversible and recoverable in terms of bending and twisting, all the above-mentioned reinforcement effects can be realized in straight-shaped as well as curve-shaped pre-manufactured part(s) 101 or curve-shaped assembly 111.

The securing element 103 utilizes one or more but not limited to the following securing mechanisms: mechanical locking means, mechanical pin, rivet, friction, adhesion, fusion, welding, threaded fastening, or any combination thereof. (Note that FIG. 1 shows a mechanical locking means as the example of securing mechanism for illustration purpose only but not for limitation.) A securing element 103 can be activated by one or more of the following methods but not limited to mechanical force (such as the jamming means 104 described below, threaded fastening, frictional force (from a surface of high friction material or coating of the slender piece 102 being pressed against another surface in the cavity 121), pneumatic or hydraulic pressure), heat (for fusion, welding, etc.), magnetic force (repelling or attracting force to drive pin or mechanical locking means containing metal interacting with magnetic field) or twisting of the slender piece (like turning a key inside a keyhole of a lock, and the key cannot be pulled out). In one embodiment, the securing element 103 can be de-activated with little to no damage on the pre-manufactured part 101 and the slender piece 102.

In a preferred embodiment, securing element 103 is purposely designed so that it will cause little to no damage on the slender piece 102 and the pre-manufactured part 101 when the user installs or uninstalls the slender piece 102 with a pre-manufactured part 101. In other words, the securing element 103 will enable the repeated installation and un-installation more than a certain number of install/uninstall cycles; whereas said certain number of install/uninstall cycles can be 5, 10, 50, 100, 500, 1000 cycles, or even higher (depending on the construction materials used, the construction tolerance, and the severity of normal wear and tear).

For example, if the securing element 103 and pre-manufactured part 101 of FIG. 1 are made of steel with good tolerance control to avoid unnecessary wear during the installation and un-installation processes, it is believed the securing element 103 and pre-manufactured part 101 can easily endure more than 1,000 installation and un-installation cycles. In a further preferred embodiment, the securing element 103 is purposely designed to be stronger (say 20%-100% stronger) than the slender piece 102. In another embodiment, the slender piece 102 is purposely designed to be stronger (say 30%-1000% stronger) than the securing element 103.

In one embodiment, the slender piece(s) 102 and the securing element(s) 103 are carefully designed not to fail together during normal use; if any of the two fail, both can be easily removed from the pre-manufactured parts 101 with little to no further damage on the pre-manufactured parts (e.g., no need to cut open the pre-manufactured parts 101) during the removal operation. The idea of “mechanical fuse” can be achieved by purposely designing either the slender piece 102 or the securing element 103 to fail before the other and the pre-manufactured parts 101 to protect the rest of components.

In one embodiment, the relative positions of the securing elements 103 with respect to the slender piece 102 are adjustable by users. For example, but not in limitation, multiple tabs (can be made of metal, plastics, composites, etc.) can be used as securing elements 103 that are pinned at the pre-manufactured holes on a slender piece 102 with equal spacing along the length direction, and a user can adjust the positions of securing elements 103 by pinning them at different holes along the slender pieces 102. In addition to pinning, the tabs can also be mounted on slender pieces 102 by methods such as but not limited to fusion/melting, adhesion, bolt and nut, riveting, and threaded fastening. Another example is that one can make a lot of securing elements 103 along a slender piece 102, and the user can choose to remove (for example, but not limited to, by cutting or by bending/tear-off) any of the securing elements 103 and only keep the securing elements at desired positions.

Optionally, a jamming means 104 may be used with the invention. The jamming means 104 helps the securing element 103 to effectively secure the slender piece 102 with one or more pre-manufactured part(s) 101. After the securing element 103 secures with the pre-manufactured part 101, the optional jamming means 104, if utilized, can be left inside, or retrieved from the pre-manufactured part 101, depending on securing mechanism used. For example, one may retrieve the optional jamming means 104 if the securing mechanism is adhesion but may not do so if mechanical locking or frictional force (not shown in FIG. 1) were used as the securing mechanism. In an embodiment, if necessary, the jamming means 104 can also be assisted with pneumatic or hydraulic pressure (e.g., running the pneumatic or hydraulic pressure in a duct inside the jamming means 104) to increase its jamming force.

After assembly of the pre-manufactured parts 101 (as indicated by 111), a gap 112 will often be present. Gap 112 can have different sizes ranging from being very tight (less than 0.1 mm) to very large (above 5 cm or more), depending on the design purpose, geometry, assembling accuracy, and thickness of the slender piece used. Nevertheless, the slender piece 102 of this invention can still effectively connect two pre-manufactured parts 101 even if a large gap is purposely designed to be placed between the two pre-manufactured parts 101. The gap 112 can be filled with fillers, sealant, sealing articles, or flexible materials if the gap is preferred not to be visible or to be leak-proof against fluid such as but not limited to water or air. For example, a ship hull (i.e., as an assembly 111) can be quickly built by assembling several 3D-printed ship hull parts (i.e., pre-manufactured parts 101) that are connected by said slender pieces 102 along with said securing elements 103 and filled with leak-proof sealing gaskets/sealing strips or flexible sealing materials in the gaps 112 between the 3D-printed ship hull parts 101. Similar approaches can also be used to quickly build a submarine hull or a vessel for containing fluid, etc.

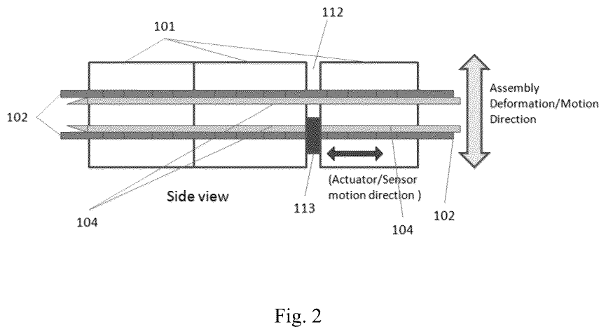

However, in some situations, the gap 112 is very useful and desired for achieving certain purposes; for example, one can insert a deformation control device 113 into the gap 112 as shown in FIG. 2 (such as a piezoelectric disk, which generates electric charges due to stress acting on it, and the piezoelectric effect is reversible by sending electrical signal to expand or contract the piezoelectric disk) in the gap to control the deformation and motion of the assembly; on the other hand, it can also convert the deformation of the assembly into electrical charges for sensing or converting continuous motion (such as vibration) of the assembly into electricity. Examples of deformation control device 113 can be but are not limited to piezoelectric disks (which can act as sensors as well as actuators), hydraulic cylinders, and other mechanical devices (e.g., power screw, pinion-rack gear system).

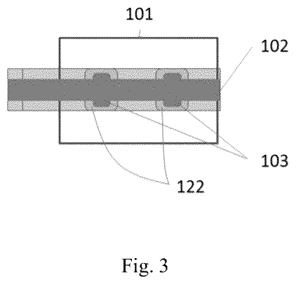

FIG. 3 shows an example of a buffer layer 122 added on the securing element 103. The buffer layer 122 is optional but is usually desired and can be important and very useful for enhancing the practicality and performance of the present invention. Buffer layer 122 can be added as the optimally-engineered cushion, coupling, and stress de-concentration interface between the pre-manufactured part 101 and the securing element 103 to help (a) transfer the mechanical load and mitigate the stress concentration issue and/or (b) create a better (or snugly) fit of the slender piece 102 and securing element 103 into the cavity 121 of a pre-manufactured part 101 with enhanced forgiveness in the part's precision requirement (this is especially practically useful for many 3D-printed parts that have less precise geometry control for small details and cavities). Note that the buffer layer 122 can also be added to the cavity 121 of the pre-manufactured part 101. The buffer layer 122 is particularly effective in increasing the strength and durability of the system and allows the system of pre-manufactured part(s) 101 of lower dimension tolerance to be assembled successfully with no or minimal re-working on the pre-manufactured part(s) 101. In one embodiment, the buffer layer 122 is doped with particle modifiers such as nanoparticles or microparticles for enhancing the desired physical properties (such as but not limited to strength, durability, more stable property against elevated temperature, and resistance to UV light caused degradation) of the buffer layer. In another embodiment, said nanoparticle or microparticle doped buffer layer 122 is piezoresistive and can be used to detect the strain experienced by said buffer layer. In a further embodiment, electrical circuits (such as printed circuits) can be used to measure the electrical resistance of said nanoparticle or microparticle doped buffer layer 122. Said nanoparticles can be but not limited to carbon nanotubes, carbon nanofibers, graphene, and other electrically conductive nanofibers or nanoparticles. Said microparticles can be but not limited to carbon blacks, carbon fibers, and other electrically conductive microfibers and microparticles.

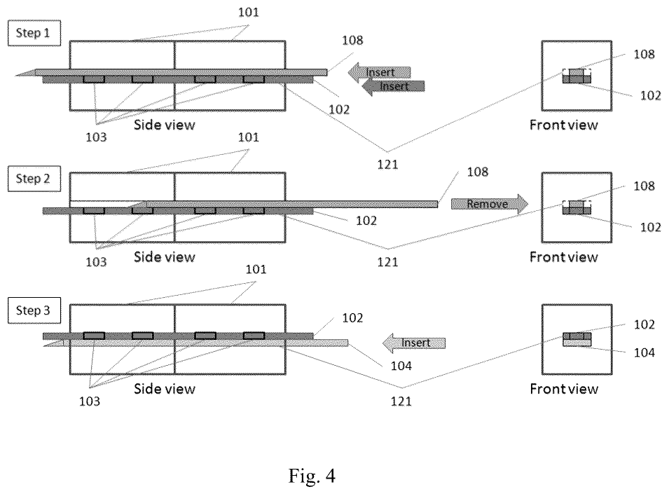

FIG. 4 shows an example of (but not for limiting) the installing/assembling procedure for connecting two pre-manufactured parts 101 using this invention. (Note that the reinforcing effect can also be achieved since strong materials such as carbon fibers are used in the slender piece 102.) In the example shown in FIG. 4, the installing/assembling procedure involves 3 simple and reversible steps. The uninstalling/disassembling process is simply to reverse the installing/assembling procedure and the movement directions. All steps are completely reversible with little to no damage to any components or parts, and all the components and parts shown in the example procedure can be repeatedly operated through many cycles of assembling and disassembling operations. As shown in FIG. 4, release guide means 108 is optional. The optional release guide means 108, when utilized, can prevent the securing element 103 of a slender piece 102 from prematurely securing with the pre-manufactured part 101, thus smoothly guiding the sliding motion of said slender piece 102 to thread through the manufactured cavity 121 inside the pre-manufactured part 101. Note that as previously described, the securing element 103 utilizes one or more but is not limited to the following securing mechanisms: mechanical locking means, mechanical pin, rivet, friction, adhesion, fusion, welding, threaded fastening, or any combination thereof. Note that FIG. 4 shows a mechanical locking means as the example of securing mechanism for illustration purposes but not for limitation. The steps of the example installing/assembling procedure shown FIG. 4 are further explained below:

Step 1: Insert the slender piece 102 and the optional release guide means 108 through cavity 121 inside the pre-manufactured parts 101. A very important issue the inventors learned during the prototype development was how to prevent the securing element 103 of a slender piece 102 from prematurely securing with the pre-manufactured parts 101 and hindering the motion of the slender piece 102 from insertion (for installation/assembling) or removal (for disassembling). In this example shown in FIG. 4, the optional release guide means 108 provides great convenience to overcome the premature securing issue. However, as to be clarified later below, the same premature securing issue could sometimes be overcome by other approaches of related physics or logics without the use of the optional release guide means 108.

Step 2: Remove said release guide means 108. Note that once the release guide means 108 is removed, there is nothing to prevent the securing element 103 of a slender piece 102 from securing with the pre-manufactured parts 101; the next step is to use the optional jamming means 104 to activate and complete the securing mechanism.

Step 3: Insert the jamming means 104 through cavity 121 inside the pre-manufactured parts 101. Said jamming means 104 pushes the slender piece's securing element 103 to secure (e.g. mechanically locks as the example shown in FIG. 4) with said pre-manufactured parts 101, therefore, successfully reinforcing and connecting one or more pre-manufactured part(s) 101.

To uninstall/disassemble the system, one can simply reverse the steps of the installing/assembling procedure and the movement directions. During step 2 of the uninstalling/disassembling procedure, the optional release guide means 108 provides a very effective and convenient means to deactivate (or release) the securing element 103 of a slender piece 102 from the pre-manufactured part 101. However, the same deactivation (or release action) of the securing element 103 could be done without the optional release guide means 108; one approach is to vibrate or twist the slender piece 102 and hopefully deactivate (or release) the securing element 103 of a slender piece 102 from the pre-manufactured part 101 (in the prototype experiments conducted by the inventors, the utilization of vibration/twisting to deactivate the mechanical locking means as illustrated in FIG. 4 sometimes worked (e.g., for small and straight connection/assembly) but sometimes not (e.g., for large or curved connection/assembly)). This alternative deactivation approach sometimes works but could be time consuming, unreliable, and could potentially cause significant part(s) damage if the user is not careful and applies too much brute force during the uninstalling/disassembling procedure; therefore, the use the optional release guide means 108 during the uninstalling/disassembling procedure is still highly recommended, though it may not always be required. It is worth mentioning that the uninstalling/disassembling procedure provided here can also be used for exemplifying how to safely remove a broken slender piece 102, which is assumed to be intentionally designed as a “mechanical fuse,” as previously mentioned, to protect other components, especially the pre-manufactured parts 101. For example, but not for limitation, one can imagine that if the slender piece 102 was broken in the midsection to serve its designed “mechanical fuse” purpose, the “mechanical fuse” will need to be replaced with a new one. To achieve such, one can simply follow the same uninstalling/disassembling procedure by operating the jamming means 104 and the release guide means 108 to retrieve the assumed broken slender piece 102 from the pre-manufactured parts 101 with little to no damage to the pre-manufactured parts 101, possibly with compressed air or other mechanical forces to help push out the broken slender piece 102 from the cavity 121 of the pre-manufactured parts 101. After removing the assumed broken mechanical fuse (i.e., the assumed broken slender piece 102), one can follow the given installing/assembling procedure to insert a new slender piece 102 to serve the designed “mechanical fuse” function to protect the pre-manufactured parts 101 again.

It is important to note that some other mechanisms can also replace the role of the optional release guide means 108 illustrated in FIG. 4. One example could be using magnetic force or gravity to control the relative position of securing element 103 inside cavity 121 and prevent the securing element 103 of a slender piece 102 from prematurely securing with the pre-manufactured part 101. Another example could be adding a long plate-like spring (e.g., linear wave spring) along the slender piece 102 to prevent the securing element 103 of a slender piece 102 from prematurely securing with the pre-manufactured part 101.

Similarly, it is also important to note that one can also decide to use other approaches to omit the use of the optional jamming means 104 illustrated in FIG. 4 to activate or deactivate the securing element 103 during the process. A securing element 103 can be activated or deactivated by one or more of following methods but not limited to mechanical force (such as the jamming means 104, threaded fastening, frictional force (from a surface of high friction material or coating of the slender piece 102 being pressed against another surface in the cavity 121), pneumatic or hydraulic pressure), heat (for fusion, welding, etc.), magnetic force (repelling or attracting force to drive pin or mechanical locking means containing metal interacting with a magnetic field) or twisting of the slender piece (like turning a key inside a keyhole of a lock, and the key cannot be pulled out).

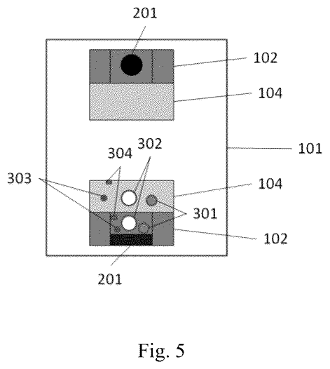

FIG. 5 shows the addition of actuators 301, sensors 303, ducts 302 (for transporting fluids or housing electrical wires), and remote signal communication device 304 can be added to a slender piece 102 and/or a jamming means 104. Optionally as well, longitudinal reinforcement 201 (such as but not limited to a continuous carbon fiber reinforced polymer composite cable, rope, rod, tape, metal wire, etc.) can also be added to a slender piece 102.

In one embodiment, actuators 301, sensors 303, ducts 302, and remote signal communication device 304 can be added to the securing element 103.

Longitudinal reinforcement 201 is to be attached to the slender piece 102 and enhance the longitudinal mechanical strength and modulus. Longitudinal reinforcement 201 can be applied to desired locations to create local reinforcement for certain design purposes or can be applied uniformly through the whole slender piece 102 to create uniform reinforcement. Longitudinal reinforcement 201 can be of different shapes such as but not limited to tape, solid cylinder, and hollow cylinder.

One or more actuators 301 can be added to the slender piece 102 or/and the jamming means 104. An actuator 301 can be wireless or wired and can be any of the following but not limited to: piezoelectric fiber, piezoelectric disk, shape-memory materials (e.g., shape-memory alloy and shape-memory polymer), liquid crystal elastomer, controllable dampers consisting of magnetic rheological fluid or electrical rheological fluid, pneumatic actuator, hydraulic actuator, solenoid pump, valve, energy radiation unit (like LED light, UV light lamp-this can be useful for many purposes such as sanitization, initial chemical reaction-infrared lamp, or radiation unit of various frequencies of electromagnetic waves), electromagnetic solenoid coil (to emit a magnetic field when running electrical current through the coil), heating element, and loud speaker (for making sound waves).

One or more ducts 302 can be added to the slender piece 102 or/and the jamming means 104 for fluid (including but not limited to gas, liquid, slurry, or any combination thereof) transportation or hosting wires, cables, or rods.

One or more sensors 303 can be added to the slender piece 102 or/and the jamming means 104. A sensor 303 can be wireless or wired and can be any of the following including but not limited to thermocouple, fiber optical sensor, insulated carbon fiber sensor, strain sensor (e.g., strain gauge), pressure transducer, force sensor, accelerometer (also known as gravity sensor), position tracker (such as satellite position tracker—e.g., GPS tracker/chip), local wireless network or Bluetooth-enabled position tracker (e.g., Apple Air Tags), microphone (for sensing sound waves, including audible and inaudible frequency ranges), light sensor (e.g., UV sensor and photoelectric sensor), electromagnetic solenoid coil (to detect magnetic field change and convert it into electrical current through the coil), Gauss meter (to detect magnetic field strength), radiation detection sensor (chip), dielectric sensor, gas sensor (for detecting specific chemical components, e.g., CO sensor), chemical sensor (or chemical sensor array), and sensor to detect electromagnetic field/signals.

The remote signal communication device 304, if present, can receive and/or send signals to communicate remotely via signals such as but not limited to electromagnetic wave, sound wave, light wave, thermal/temperature wave, and change of chemical species or scent concentration (such as the communication means of ants or bees).

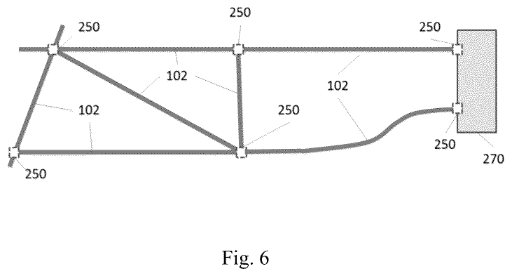

FIG. 6 illustrates that, when needed, two or more slender pieces 102 can be connected through a slender-piece-connecting-means 250. It also illustrates that a slender piece 102 can be connected to an external object 270 through slender-piece-connecting-means 250. The slender-piece-connecting-means 250 is for connecting two or more slender pieces 102 as shown in FIG. 6. In some scenarios, one may need to connect two slender pieces 102 for a longer assembly. In some other scenarios, one may want to connect multiple slender pieces 102 into a network or truss-like reinforcement structure. In another scenario, one may want to use one or more slender pieces 102 to connect to an external object 270. For example, the external object 270 could be an armor panel or a shell that one would prefer is mounted on slender pieces 102 for better load-bearing and cheaper repair/replacement rather than the pre-manufactured parts 101. The location of the slender-piece-connecting-means 250 can be either inside a pre-manufactured part 101 or outside a pre-manufactured part, depending on the needs and purposes. The slender-piece-connecting-means 250 can connect multiple slender pieces 102 using one or more but not limited to following approaches including mechanical locking means, riveting, bolting, pin, adhesive bonding, fusion/welding, threaded fastening, and any combination thereof. In one embodiment, the slender-piece-connecting-means 250 can also include a sealing means such as gaskets/sealing kits to water-tight or gas-tight the ducts 302 inside the connected slender pieces 102. In another embodiment, slender-piece-connecting-means 250 may also provide additional reinforcement such as adding carbon fiber reinforced polymer or strong metal fixtures to further reinforce the joint between the connected slender pieces 102.

In some applications, the slender piece 102, securing element 103, and jamming means 104 may interact through signal, energy transfer, or mass transfer (fluid) with device(s) inside a pre-manufactured part(s) 101 and/or an assembly 111. Hence, appropriate connecting ports can be placed on one or more of the following components: slender piece 102, securing element 103, and/or jamming means 104, whereas the ports connect to the devices inside the pre-manufactured part(s) 101 and/or the assembly 111.

The present invention is very useful since it provides many novel and useful advantages, features, functions, methods, or possible uses over the prior art, including but not limited to the following points:

1. Easy connection of pre-manufactured parts: Use one or more strong and flexible slender piece(s) consisting of carbon fiber or other strong structural materials of a long aspect ratio (i.e., slenderness ratio) along with securing element(s) to insert into at least two pre-manufactured parts and connect the pre-manufactured parts.

2. Easy connection of pre-manufactured parts of multi-material systems: Use one or more slender piece(s) consisting of carbon fiber or other strong structural materials to connect parts consisting of different materials, e.g., connecting PLA parts to silicone parts is difficult to be done effectively via adhesives or other joining methods, but it can be done easily and effectively by this invention.

3. Easy reinforcement of pre-manufactured part(s): Use one or more slender piece(s) consisting of carbon fiber or other strong structural materials of a long aspect ratio along with other features to insert into one or more pre-manufactured part(s) and create reinforcing effects to the part(s).

4. Provide integrity and strengthen the assembly beyond the original strength of the pre-manufactured part(s): Due to the significantly higher strength of the material used in the slender piece than the materials used in the pre-manufactured part(s), the entire section in which it is implemented can be immediately reinforced.

5. Maintain and enhance the integrity of the assembly consisting of one or multiple of the pre-manufactured parts: With the strong slender piece(s) connecting throughout the assembly through engineering-selected locations and a means of securing with the pre-manufactured parts in terms of statics or dynamics principles, a person can enhance the assembly's mechanical integrity for taking the mechanical load, whereas the assembly can be used like but not limited to a beam, truss, torsion bar, car chassis, air-plane wing, wind turbine blade, etc.

6. Be able to connect multiple pre-manufactured parts (for example, size-limited 3D-printed parts) into very large or very complex assemblies: Such very large or complex assembles can be but not limited to bridges, car chassis, airplane wings, ship hulls, submarine hulls, fluid containers, wind turbine blade, bicycle frame, bridges, armors for personnel or vehicles, etc. The slender piece(s) can also be used to connect and reinforce large assemblies, while the pre-manufactured part(s) can provide the other desired functions of the purpose of the assembly as well as to provide the structural interaction with the slender piece(s).

7. Enable slender pieces to be inserted and easily installed into place, in the pre-manufactured part(s): This can be done through various designs of securing elements to accommodate different systems of pre-manufactured parts.

8. Enable slender pieces to directly melt, bond, and insert at a designated depth into the pre-manufactured parts: The slender piece(s) should be easily inserted into the pre-manufactured parts with designated depth under or even flush with the surface of the pre-manufactured parts, so that the installed slender pieces won't extrude from and change the outer geometry of the pre-manufactured parts.

9. Easy removability of the slender piece(s) from the pre-manufactured part(s): Some of the common methods to join reinforcing sub-structure(s) with a pre-manufactured part(s) include adhesives and melting/welding. However, these methods result in difficulty or sometimes complex operations to separate the parts once joined. One version of the slender piece to resolve this issue could be through a physical connecting/locking mechanism, which can be easily removed if needed. However, it is still optional and possible for adhesion and melting/welding to be used to install the slender piece inserted into the parts, but it may prove to be more tedious to remove.

10. Easy disassembling of system consisting of connected pre-manufactured parts for easy repair, modification, storage, or transportation of the system: As the slender piece has easy removability, the system and its connections can be disassembled with minimal effort (compared with other joining methods such as adhesives, welding, riveting, screw-fastening (which may require the labor-intensive removal of many screws, where some could be difficult to access or could be significantly damaged during the screw removal process, to disassemble several pre-manufactured parts from an assembly)), for easy repair, modification, storage, or transportation, etc.

11. Provide flexible slender pieces to be used in various dimensions or curved shapes: For each market segment and industrial application, the slender piece will have optimized small dimension (i.e., thickness) in the direction perpendicular to its length, thus allowing the slender piece to be bent and twisted easily while retaining strong tensile strength and compressive strength (in the length direction). Furthermore, flexible materials such as carbon fiber reinforced flexible matrix (such as but not limited to rubber, silicone, nylon, epoxy, polyester, PLA, etc.) can be used to provide enhanced flexibility of the slender piece.

12. Enable lightweight and high strength assembly of the pre-manufactured parts: With proper engineering structural design, the assembly's integrity and mechanical load can be mainly carried by the significantly stronger slender pieces. Therefore, the pre-manufactured parts can be designed as hollow structures with a minimal amount of materials used and save weight, material usage, and manufacturing cost. If the slender piece is made of lightweight carbon fiber reinforced polymer (such as but not limited to rubber, silicone, nylon, epoxy, polyester, PLA, etc.) composite, which can be very strong and lightweight, the assembly of the pre-manufactured parts connected by the slender pieces can be engineered as very strong and lightweight and yet with minimized materials usage and cost (as well as the part production time and energy consumption if by 3D printing), which could find usefulness in applications such as electrical airplane or lightweight deployable bridge.

13. Utilize the slender piece(s) to effectively deliver mechanical load between two or more assemblies: Note this is different than connecting two or more pre-manufactured parts with slender pieces. For example, an assembly of weaker or fragile (or can be softer, chemically less stable, reactive, or explosive, etc.) material, which is reinforced with slender piece, can be connected to a second assembly of stronger material by connecting the second assembly through the slender pieces embedded inside the weaker assembly. Since the slender pieces are very strong and can uniformly distribute the mechanical load through the securing elements into the first weaker assembly, the weaker or fragile assembly will have less chance to break.

14. Provide at least one of the following mechanical supports to the reinforced parts or assembly: The mechanical supports can include the supports against tension, compression, bending, torsion, shear, and any combination thereof.

15. Make the slender piece(s) reusable.

16. Enhance the recyclability and reusability of the pre-manufactured parts: With the slender pieces, some types may be able to be removed easily without damaging the pre-manufactured parts.

17. Allow for the saving of materials due to the strengthening and reinforcing effects of the slender piece(s), thus allowing the use of less material in the pre-manufactured part(s).

18. Enable the modularized design of the pre-manufactured parts to be assembled in flexible and creative manners: As the slender piece can be removed, the pre-manufactured parts are able to be reused. Therefore, a modularized design of these pre-manufactured parts will provide standardized and convenient options for consumers to assemble the modularized pre-manufactured parts with many different and flexible combinations, while still maintaining compatibility between the individual pieces.

19. Slender pieces can have holes to accommodate fasteners (e.g., pins, screws).

20. Allow for easy storage of the slender pieces in compact manner to be stored or transported.

21. Multiple slender pieces can be extended or retracted to be set with fixtures/pins (e.g., the slender pieces can be hollow with multiple layers of slender pieces to slide against each other for extension or retraction): The slender pieces can also be effectively stored through retractable functions. A set of multiple slender pieces can have a hollow interior that holds multiple layers of slender pieces to extend or retract, and the length of the slender pieces set can be adjusted and then fixed with fixtures such as pins or screws.

22. Provide great tolerance forgiveness for pre-manufactured parts when being assembled: Connecting and locking versions of the slender piece will need to fit within the assembly to connect them. However, gaps between the slender piece and the pre-manufactured parts may still be present. To address this, one option to increase the tolerance forgiveness is to create a buffer layer (i.e., cushion layer) between the slender piece and the pre-manufactured parts to fill the additional space and effectively hold the slender piece snugly.

23. Provide versatile structural connectivity: In one embodiment, an external shell can be added outside of the pre-manufactured part(s) or assembly and said external shell can be mounted on multiple slender pieces that are inserted/embedded inside the pre-manufactured part(s) or assembly to create a cohesive system. In another embodiment, multiple said slender pieces inside the pre-manufactured part(s) or assembly can be melted and/or bonded together through fusion or mechanical fastening (e.g., insert pin) to create a truss-like reinforcement system to the pre-manufactured part(s) or assembly. Said multiple slender pieces can also be detached from each other through melting or removal of fastener(s).

24. Use the slender pieces or the securing elements as “mechanical fuses” to protect the pre-manufactured part(s) or/and the assembly or the linked assemblies: When a structure or machine is taking mechanical load beyond its capacity, the failure will first occur at the weakest point and then the load distribution will change, which could yield further damage propagation into total failure, but the further damage propagation could be stopped if the connection to the load source being cut-off by a “mechanical fuse”. The slender pieces or the securing elements as “mechanical fuses” can protect the pre-manufactured part(s) or/and the assembly or the linked assemblies with properly positioned slender pieces or securing elements based on a careful structural analysis that considers the “mechanical fuses” to be placed in the system. Since the slender pieces and the securing elements (either intact or broken ones) can be easily removed from and installed into the system, the “mechanical fuses” can be easy to remove and replace.

25. Use the invention for better implants for the human body: In an example of the application but not in limitation, said pre-manufactured part(s) or assembly can be an implant in the human body, wherein said slender piece(s) and its related accessories provide the function to reinforce and strengthen said implant inside the human body. With both the lightweight and strengthening characteristics of the slender pieces and the ability to reinforce and connect pre-manufactured parts of different materials, one can create implants consisting of the most optimal selection and combination of bio-compatible materials and mechanically compatible materials. Said slender piece(s) and its related accessories can be updated along with the treatment course to provide the corresponding updated desired function. Therefore, the longevity of said implant and/or medical treatment process can possibly be improved.

26. Utilize sensors in the slender piece(s) and/or jamming means to sense physical property changes of the part and system: An example of this can be to embed the carbon fiber sensor in the slender piece for the health or stress/strain monitoring of the parts and system. Another example could be placing different sensors in several pieces of jamming means, and one can insert different jamming means in the pre-manufactured part for different sensing purposes/missions. The sensors can be but are not limited to carbon fiber sensors, thermocouples, strain gauge, piezoelectric sensor, etc.

27. Enable sensors inside the slender pieces and/or jamming means to monitor the processing and curing/melting fusion joining/solidification with other slender pieces and/or pre-manufactured parts: If a slender piece is to be joined with other slender pieces or pre-manufactured parts through a process involving curing of adhesive, melting fusion joining, or solidification of joining area, sensors embedded in the slender piece can also help to detect the changes in temperature, stress/strain, expansion/shrinkage of the material such to allow one to monitor the process. The sensors can be but are not limited to carbon fiber sensors, thermocouples, strain gauge, piezoelectric sensor, etc.

28. Utilize the slender piece's carbon fiber to create electric resistance for Joule heating on the pre-manufactured part and slender piece: If the slender piece contains conductive fiber (such as carbon fiber or other filament of conductive materials but significantly less conductive than copper), electrical current can be applied to the conductive fiber to heat the slender piece and the pre-manufactured part. The Joule heating can be used for controlling the temperature of the system and also can be used to melt and weld the slender piece (if made of metal, thermoplastic, etc.) onto or off the pre-manufactured part or connect to the other slender piece(s).

29. Actuate or deform the pre-manufactured part/assembly through shape-memory materials (including shape-memory alloys or polymers) embedded in or working together with the slender piece(s): Shape-memory alloys or polymers can return to its trained shape immediately if the temperature reaches or exceeds the on-set temperature. It can also be plastically deformed at lower temperatures. Thus, by changing the temperature of slender piece, the shape-memory alloys or polymers embedded in or positioned nearby to work together with the slender piece(s) can be driven by the temperature change of the slender piece(s) and actuate or deform the pre-manufactured part/assembly.

30. Enable the electrical wire and actuators embedded through a slender piece and/or its associated accessories (i.e., optional jamming means, ducts, sensors, actuators, and remote signal communication devices) inside pre-manufactured part(s) or the assembly to stimulate the motion and/or increase the strength of human body tissues, bones, and/or other living organisms as well as to move the pre-manufactured part(s) or the assembly: For example, prosthesis made of pre-manufactured part(s) with the inserted slender pieces, where the actuators (such as the shape-memory fibers) embedded through the slender pieces or/and the associated accessories can help move the prosthesis. For another example, the proper electricity or vibration of an actuator could be used to stimulate the nearby human muscle or bones for growth or motion.

31. Dampen the vibrations of the pre-manufactured part(s) or assembly through passive, adaptive, and active manners: For example, a slender piece and/or its accessories could include some passive damping materials such like rubber or other viscoelastic materials. In other scenarios, adaptive dampers such as dampers containing magnetic rheological fluid or electric rheological fluid can also be used to adaptively adjust the damping coefficient to reduce the vibration. On the other hand, a slender piece and/or its accessories could include some active damping devices such as but not limited to piezoelectric devices (like disk, fiber, etc.) to convert deformation or relative motion (transfer through the slender piece, its accessories, and/or the pre-manufactured part or assembly) into electricity to achieve energy harvesting/recycling along with dampening of the vibration. In another example, the piezoelectric device can also be excited by electrical signal to actively cancel or reduce the vibration of the pre-manufactured part or assembly.

32. Combine the piezoelectric elements with/into the slender piece(s) to actuate and/or detect deformation of the pre-manufactured part/assembly: Piezoelectric disks or fibers can deform when receiving electrical signal and can send electrical signal (voltage) when under deformation, so they can be combined with/into the slender piece(s) to actuate and/or detect deformation of the pre-manufactured part/assembly.

33. Utilize the piezoelectric elements or other energy conversion devices (such as but not limited to an electromagnetic coil to convert motion into electricity) combined into/with the slender piece(s) and/or associated accessories (i.e., optional jamming means, ducts, sensors, actuators, and remote signal communication devices) to harvest and convert kinetic energy from the environment into electrical energy and transport the electrical energy through the slender pieces and/or wireless setting: An example of this can be an assembly of pre-manufactured parts floating on ocean. When the assembly is deformed by the wave (kinetic energy from the ocean), the piezoelectric elements or other energy conversion devices combined into/with the slender piece(s) and/or associated accessories can convert such deformation into electricity. The electricity is then transported through the wire inside the slender piece(s) or though wireless electricity transmission.

34. Enable the piezoelectric elements combined into/with the slender piece(s) and/or associated accessories (i.e., optional jamming means, ducts, sensors, actuators, and remote signal communication devices) to monitor the sound of the surroundings: An example of this could be a 3D-printed parts assembled toy (or robot) with the piezoelectric elements to detect the vibration transmitted from the skin of one or multiple 3D-printed parts of the toy (or robot); then, the vibration signals collected by the piezoelectric elements, depending on the magnitude and frequency can be interpreted (by a computer or signal analysis chip/device) as impact, touch, human speaking, music, or ultrasound, etc.; then, the toy (or robot) can feel and listen from its environment and users (children who are playing the toy) and possibly interact with the users and environment.

35. Enable the piezoelectric elements combined into/with the slender piece(s) and/or associated accessories (i.e., optional jamming means, ducts, sensors, actuators, and remote signal communication devices) to emit signals and/or sound waves into the environment: An example of this could be a 3D-printed toy that could also play music or sing songs; or a 3D-printing art piece/furniture can also play music. Since the piezoelectric elements can also be used as actuators when excited by electrical charges/currents, they can vibrate the 3D-printed toy, art piece, or furniture and emit the sound waves from the skin/surface into the environment.

36. Enable piezoelectric elements combined into/with the slender piece(s) and/or associated accessories (i.e., optional jamming means, ducts, sensors, actuators, and remote signal communication devices) for converting between signal, auditory, and physical/vibrational communication: An example of the use of this technology could be inserting of such slender pieces into the pre-manufactured part(s) or assembly for a seat, wheelchair, or/and wearable devices to help people with disabilities to sense and communicate. The sound from the environment detected by the piezoelectric elements combined into/with the slender piece(s) could be translated (by a computer or an analysis device/chip) into recognized vibrational patterns (such as Morse code) to be fed to the user with hearing/speech disability. Then, the user with disability moves certain muscles with recognized vibrational patterns (such as Morse code) to be detected by the piezoelectric element(s) and translated into spoken language. Finally, the piezoelectric elements along with the slender pieces, and/or the assembly can emit the sound waves of the meaningful spoken language to the environment and heard by the other people around; therefore, a communication between a user with hearing and speech disability and other people can be accomplished smoothly and effectively. Also, the communication of digital data can be saved locally or uploaded to Cloud space for human or AI Consolers to protect the rights of the user with hearing and speech disabilities.

37. Allow hollow structure to be embedded in said slender piece(s) and/or its related accessories for fluid (e.g., liquid, gas, slurry, or combination thereof)) transport: Said fluid can be used for heat transfer and/or mass transfer (or certain chemicals, nutrition, fuel, etc.)

38. Allow hollow structures of the slender piece(s) and its related accessories to assist in transporting fluid in the human body/medical applications (e.g., fluid could be bio-functional fluids or medicine) if the pre-manufactured piece is a part of implant in human body.

39. Use said hollow structure of the slender piece(s) and its related accessories for holding wires or cable-like devices (such as but not limited to an endoscope and an endoscope-robot) inside.

40. Connecting two or more slender pieces with a gearbox to control the shape/curvatures of the assembly of pre-manufactured parts: The gearbox can alter the relative displacements of said connected slender pieces to achieve the function of controlling the shape/curvatures of the assembly of pre-manufactured parts.

41. Enable visualization of the function in-working of the pre-manufactured parts or assembly: Said pre-manufactured parts can be made of transparent material to enable visualization of working mechanism, fluid transport, and monitor of the health of property change of physics or chemistry inside the structure such as mechanical displacement, stress, strain, temperature, humidity, acidity (pH) level, environmental chemical composition, radiation, and any combination thereof. Since the majority of mechanical load is taken by the slender pieces, it allows broader ranges of material selections (including transparent materials) and design options (such as thin-wall design with transparent portion or hollow portion to enable the visualization of the functions in-working) for the pre-manufactured parts or assembly.

42. Enable energy and mass transportation function in the pre-manufactured parts or assembly: Said slender pieces and its systems (including but not limited to sensors, actuators, energy conversion devices, internal ducts, and its related accessories) can work together to provide the energy and mass transportation function including but not limited to fluid transportation, heat transfer, mixing a fluid with the other compounds, energy harvest/transport, or any combination thereof.

43. Enable the slender pieces and its systems to be monitored and controlled with computer systems.

44. Enable the slender pieces and its systems to be monitored and controlled with artificial intelligence (AI).

45. Enable the slender pieces and their systems to be monitored and controlled through wireless, wired signals, and/or energy transmissions.

46. Enable the slender pieces and pre-manufactured parts and the sensors, actuators, mass transport, and energy transport in an assembly to be used for robotics and/or augmented reality.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. The headings, lists, and numbering included herein are for ease of explanation only and are not meant to be limiting.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated. As used herein, the singular forms “a”, “an” and “the” are intended to include the plural forms as well, unless the context clearly indicates otherwise. Although particular embodiments of the present disclosure have been described, it is not intended that such references be construed as limitations upon the scope of this disclosure except as set forth in the claims.

We claim:

1. A method and apparatus for connecting and reinforcing pre-manufactured parts as shown and described herein.
